(19) United States
(12) Patent Application Publication
(10) Pub. No.: US 2015/0286945 A1
(43) Pub. Date: Oct. 8, 2015

(54) Artificial Intelligence System and Method for Making Decisions About Data Objects

(71) Applicant: Vertical Data, LLC, Bath, OH (US)

(72) Inventors: Gregory B. Brewster, Evanston, IL (US); Christopher T. Wolff, Bath, OH (US)

(21) Appl. No.: 14/676,500

(22) Filed: Apr. 1, 2015

Related U.S. Application Data
(60) Provisional application No. 61/974,669, filed on Apr. 3, 2014.

(51) Int. Cl. G06N 5/04; G06N 99/00

(52) U.S. Cl. CPC G06N 5/045; G06N 99/005

(57) ABSTRACT

A computer-implemented method for making decisions on data objects is provided. The method includes the steps of receiving data objects in a computer, applying a first artificial intelligence method to a data object, and applying a second artificial intelligence method to the results from the application of the first artificial intelligence method.

### BACKGROUND

This invention relates to a method and system that utilizes one or more artificial intelligence methods to make decisions about data objects. The data objects may be e-mails, documents, photos, videos, audio files or other data items that arrive to an organization. For each new data object, the system and method will automatically make one or more decisions based on the contents and metadata associated with the new data object. For each decision, the system will select one or more values from a discrete set of possible outcomes for that decision.

The metadata associated with a data object includes all data object components that are accessible and inaccessible to the user, including all XML tags, HTML tags, configuration data, file headers, and anything else that is contained within the data object. The metadata associated with a data object also includes all data pertaining to that data object which can be found through a lookup or search, including data available through data table lookups, database lookups, Document Management System (DMS) metadata table lookups, DMS searches, and Internet searches. This includes all metadata that can be generated by a human, a computer, or any artificial intelligence method.

Artificial intelligence methods that the system may use include Expert Systems methods, Knowledge Representation methods, Machine Learning methods, and Natural Language Processing methods.

Expert Systems methods attempt to duplicate human decision-making processes about data objects by applying automated reasoning models to data object content and metadata. Examples of automated reasoning models used in Expert Systems methods include If/Then Rules, Lookup Tables, Decision Trees, Deductive Reasoning, Pattern Matching and Weighted Factor Matrices.

Knowledge Representation methods include those that construct a data structure to store the data object and its metadata, while also representing data object properties, categories, and states, as well as the causal and non-causal relationships between them. Examples of knowledge representation methods include object graphs, tags, knowledge bases, databases, contextual knowledge, commonsense knowledge, and computational intelligence models.

Machine Learning methods provide results that can be improved automatically through experience. Some of these methods determine outcomes using predictive analysis techniques and other forms of statistical analysis. Some of these methods make decisions by calculating confidence values or likelihood measures for each possible outcome and then selecting the most likely outcome. Some of these methods utilize Supervised Machine Learning methods, in which the system is given a set of training examples consisting of data objects with predetermined decision outcomes. Some of these methods utilize Unsupervised Machine Learning methods that detect patterns in sets of data objects without prior training. Examples of Machine Learning methods include Bayesian analysis, nearest centroid classifiers, random forests, support vector machines, k-nearest neighbor classifiers, and neural networks.

Natural Language Processing methods determine semantic meanings from text that is expressed in the languages that humans speak. These methods allow systems to gain knowledge from sources such as news stories, free-text user interfaces, and spoken audio input. Examples of Natural Language Processing methods include automatic summarization, discourse analysis, machine translation, parsing models, sentiment analysis, speech recognition, natural language search, and information extraction.

Categorization systems or classification systems are decision-making systems in which the system selects a category-value—also called a label value, a tag value, a property value, or an attribute value—from a discrete set of possible category-values associated with a category-type. Categorization serves to (a) break data objects into smaller sets that can be more easily browsed by users, (b) permit users to limit searches based on category attributes, (c) determine where the data object should be stored and how long it should be retained, (d) identify a group of data objects for special treatment (e) route data objects to specific persons for notification, approval or other purposes, (f) determine the security status for the object (for example, spam detection), in addition to other purposes. Applications of categorization systems include Fraud Detection, Document Routing, Spam Detection, Search Indexing, data object tagging, Intrusion Detection Systems, Business Analytics, Financial Risk Assessment, Health Informatics Systems, data mining and more.

In categorization systems, organizations define one or more category-types and a set of permitted category-values within each category-type. Examples of category-types are Security Status, Date Received, Document Type, Location, Project Code, etc. Each category-type has a set of permitted category-values. For example, the category-values for Security Status might be {Top Secret, Secret, Classified, Unclassified}. Category-values for the “Date-Received” category-type would be calendar dates such as “Feb. 19, 2013”, etc.

Methods and systems that utilize artificial intelligence methods to make decisions about data objects may benefit from improvements.

### SUMMARY

The following is a brief summary of subject matter that is described in greater detail herein. This summary is not intended to be limiting as to the scope of the claims.

A computer-implemented method for making decisions on data objects is provided. The method includes the steps of receiving data objects in a computer, applying a first artificial intelligence method to a data object, and applying a second artificial intelligence method to the results from the application of the first artificial intelligence method.

In another aspect of an exemplary embodiment, a computer-implemented method for making decisions on data objects is provided. The method includes the steps of a) receiving data objects in a computer; b) applying a first artificial intelligence method to the data object; c) determining if the first artificial intelligence method selects a decision outcome for the data object; d) if the first artificial intelligence method selects a decision outcome for the data object, then storing the decision outcome in the data object meta data; and e) if the first artificial intelligence method does not select a decision outcome for the data object, then applying a second artificial intelligence method to the results from the application of the first artificial intelligence method.

In another aspect of an exemplary embodiment, a non-transitory computer-readable medium for making decisions on data objects includes instruction stored thereon, that when executed on a processor, perform the steps of receiving data objects in a computer, applying a first artificial intelligence method to a data object, and applying a second artificial intelligence method to the results from the application of the first artificial intelligence method.

Other aspects will be appreciated upon reading and understanding the attached figures and description.

### BRIEF DESCRIPTION OF THE DRAWINGS

FIG. 1 is a schematic view of an exemplary embodiment of a system for making decisions about data objects.

FIG. 2 is a flow diagram of that illustrates an example of a decision process for a data object.

FIG. 3 is a flow diagram of an example of a decision feedback process for a data object.

FIG. 4 is a flow diagram of an example of a category value selection process for documents that uses an expert system and machine learning system to process the documents in accordance with the system of claim 1.

FIG. 5 is a flow diagram of an example category feedback process that may be used in the category selection process of FIG. 4.

FIG. 6 is a block diagram of a category tree utilized in the category selection process of FIG. 4.

FIG. 7 is a chart showing the details of the document term vector calculation of the category selection process of FIG. 4.

### DETAILED DESCRIPTION

Various technologies pertaining to the embodiments will now be described with reference to the drawings, where like reference numerals represent like elements throughout. In addition, several functional block diagrams and flow diagrams of example systems are illustrated and described herein for purposes of explanation; however, it is to be understood that functionality that is described as being carried out by certain system components and devices may be performed by multiple components and devices. Similarly, for instance, a component/device may be configured to perform functionality that is described as being carried out by multiple components/devices.

Artificial intelligent systems may take the form of several examples. For example, the objective of the system may be to automatically select the same decision outcomes that would be selected by a Subject Matter Expert (SME). This SME may be a person, a group of people, or a set of standards that determine a set of correct decision outcomes for each data object. In some systems the SME will choose the specific models, data structures, control structures and parameters for each artificial intelligence method utilized. In some systems, the SME will choose training examples that are used by any of the computer assisted or mediated methods. In some systems, the SME will train the system in multiple ways. In some systems, the data objects may be used by a single person (the ‘user’). In some of these systems, the organization delivering the data to the user will act as the SME. In some of these systems, each user will act as his/her own SME.

Some systems will utilize a single artificial intelligence method to make a decision. One example of a Spam Detection system that utilizes a single Knowledge Representation method is a system that creates a word frequency database for each data object and then selects a result of “spam” if the data object contains certain words and “not spam” otherwise.

One example of a Spam Detection system that utilizes a single Expert Systems method is one that utilizes a decision tree created by an SME wherein each interior node of the tree contains a question regarding the data object contents and metadata, and each question node contains outgoing arcs labeled with each possible answer to the question, and each leaf node of the decision tree provides a result of “spam” or “not spam”.

One example of a Spam Detection system that utilizes a single Machine Learning method is one in which an SME provides many examples of data objects that have previously been categorized as “spam” or “not spam”. The system then does clustering analysis on these training examples and uses a best-fit likelihood measure to determine whether a new data object is most similar to data objects previously identified as ‘spam’ or ‘not spam’.

One example of a Spam Detection system that utilizes a single Natural Language Processing method is one in which the English text within each data object is analyzed for sentiment analysis. Data objects whose text contains sentiments that are identified as suspicious or threatening will be labeled as spam.

There are several disadvantages that can result from the use of individual artificial intelligence methods in isolation. For example, knowledge Representation methods used in isolation cannot represent some decision processes accurately and may not be able to represent all types of data object relationships. Expert Systems methods used in isolation often require significant SME time and effort to construct. Expert Systems methods also may have a very large number of possible input cases. In addition, SMEs cannot always explain their reasoning processes through formal logical constructs, resulting in an SME response of “I just know it when I see it” or other judgment calls which cannot be encoded into the formal model.

Machine Learning methods used in isolation may have the following disadvantages. They cannot represent deterministic decision processes well. They often require very large numbers of training examples to achieve accurate results, and they suffer from the “curse of dimensionality” which results in inaccurate results when working with systems that have a large number of variables.

Natural Language Processing methods used in isolation may have the following disadvantages. They may not be able to accurately interpret unusual grammatical structures. They may need to deal with ambiguous syntax or semantics. They may not be able to correctly interpret linguistic context, such as humor or sarcasm, and they may not be able to provide meaningful results for all possible inputs.

In some embodiments the system will utilize multiple artificial intelligence methods to make a decision. In these embodiments the use of multiple artificial intelligence methods may eliminate or reduce the disadvantages that can result from the use of individual artificial intelligence methods in isolation.

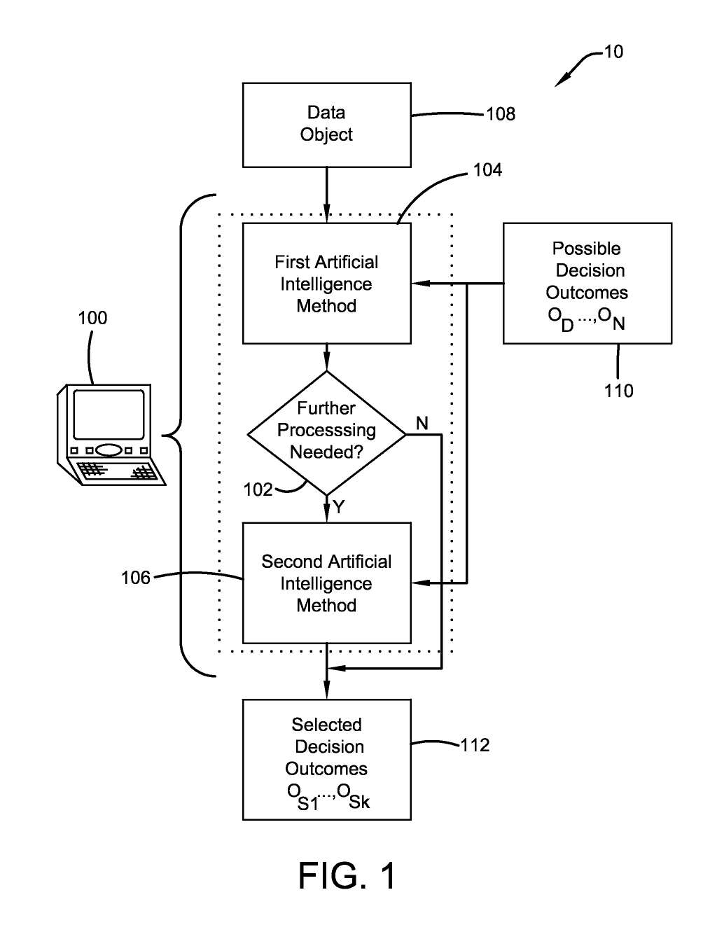

Referring to FIG. 1, an exemplary embodiment of an artificial intelligence system 10 for making decisions about data objects is shown. This system uses multiple artificial intelligence methods. In particular, the system includes a computer 100.

The functions of the computer described herein may be implemented using computer executable instructions (e.g. whether software or firmware) operate to execute in one or more processors. Such instructions may be resident on and/or loaded from computer readable media or articles of various types into the respective processors. Such computer executable software instructions may be included on and loaded from one or more articles of computer readable media such as firmware, hard drivers, solid state drives, flash memory devices, CDs, DVDs, tapes, RAM, ROM and/or other local, remote, internal, and/or portable storage devices placed in operative connection with the described system and other systems described herein.

The computer 100 may include a processor 102 such as a Central processing unit (CPU). The computer 100 may include a first artificial intelligence module 104 and a second artificial intelligence module 106. A data object 108 may be sent to the computer 100. As previously mentioned, the data object 108 may be an e-mail, document, photo, video, audio file or other data item that arrives to an organization. The data object may be a text object. For each new data object 108, the system will automatically make one or more decisions based on the contents and metadata associated with the new data object. For each decision, the system will select one or more values from a discrete set of possible outcomes for that decision.

The metadata associated with a data object includes all data object components that are accessible and inaccessible to the user, including all XML tags, HTML tags, configuration data, file headers, and anything else that is contained within the data object. The metadata associated with a data object also includes all data pertaining to that data object which can be found through a lookup or search, including data available through data table lookups, database lookups, Document Management System (DMS) metadata table lookups, DMS searches, and Internet searches. This includes all metadata that can be generated by a human, a computer, or any artificial intelligence method.

The first and second artificial intelligence modules may include Expert Systems methods, Knowledge Representation methods, Machine Learning methods, and Natural Language Processing methods.

When the computer receives the data object, the first artificial intelligence module is applied to or processes the data object. After the first artificial intelligence module has been applied, the system checks whether a decision outcome has been determined. If the first artificial intelligence module has selected a decision outcome 110, then that decision outcome 110 is stored in the data object metadata. On the other hand, if the artificial intelligence module did not select a decision outcome, then second artificial intelligence module is applied to or processes the data object. If the second artificial intelligence module selects a decision outcome 112, then that decision outcome 112 is stored in the data object metadata. Alternatively, a third artificial intelligence module may be applied to the data object. It should noted that application of the third artificial intelligence method is iterative and with no specific limit.

In some exemplary embodiments that use multiple artificial intelligence methods, a Natural Language Processing method is applied to the data object text before the other artificial intelligence methods are applied. The results of the NLP analysis can be used to (a) reduce the number of possible decision outcomes, (b) limit the data object properties to be used in making the decision, and/or (c) set other data object metadata values. By reducing the number of possible outcomes and/or the number of data object properties to be considered, the NLP analysis will reduce the computational complexity of the decision task for other artificial intelligence methods that are applied afterwards.

In some exemplary embodiments that use multiple artificial intelligence methods, an Expert Systems method is applied to the data object before a Machine Learning method is applied. These embodiments are referred to as “ES-ML embodiments” in the text below.

In ES-ML embodiments, the Expert System method can reduce computational complexity and increase accuracy for the Machine Learning method by (a) reducing the number of possible decision outcomes, (b) limiting the data object properties to be used in making the decision or (c) setting other data object metadata values. The SME effort required to construct the Expert System model can be significantly reduced, compared to a system using an Expert System model in isolation, due to the fact that every possible decision outcome does not need to be uniquely determined by the Expert System method. The Machine Learning method will be applied to data objects for which an outcome was not determined by the Expert System model. Compared with a Machine Learning model used in isolation, the Machine Learning model that is applied after an Expert Systems model will require less training and will make use of fewer object variables based on the results of the Expert Systems method. Further, this multi-method system may be able to correctly categorize some data objects that would not be correctly categorized by either the Expert Systems method or the Machine Learning method in isolation.

In some exemplary embodiments that use artificial intelligence methods, an unsupervised machine learning method is applied before a supervised machine learning method is applied.

In some exemplary embodiments, decisions made by the Machine Learning method are marked as ‘unconfirmed’ until they have been confirmed by an SME. Once these decisions have been reviewed by the SME and verified to be correct then they are marked as ‘confirmed’.

In some ES-ML embodiments, the system passes through three phases:
1. Construction and Training Phase: The SME initially chooses the Expert Systems model and Machine Learning model to be used. The SME then initializes operational parameters for these models by:
   a. Constructing rules, decision trees, patterns, and other decision constructs in the Expert Systems (ES) model.
   b. Providing a set of data objects and their correct decision outcomes, to be used as training examples for the Machine Learning (ML) model.
2. Testing Phase: In this phase, new data objects go through the Data Object Decision Process shown in FIG. 1 for each decision to be made about the data object. Decision outcomes that are selected by the ES model are marked ‘confirmed’ and require no further review. Decision outcomes that are selected by the ML model are marked ‘unconfirmed’ and may be reviewed by the SME immediately or at a later time through the Decision Feedback Process shown in FIG. 1. In the Decision Feedback Process, the SME examines the data object and the unconfirmed decision outcome selected by the ML model. The SME then provides feedback as to whether this outcome is correct or not. The ML model uses this feedback to modify its processing of future data objects. For some incorrect decision outcomes, the SME may determine that changes need to be made to the ES model as well.
3. Production Phase: Once the SME has provided sufficient feedback and modifications so that the Data Object Decision Process is providing accurate results, then new data objects are sent through the Data Object Decision Process shown in FIG. 1. Now the SME does not need to provide feedback for every decision made by the ML model, but may optionally provide occasional feedback to fine-tune the system. In this phase, the current system configuration (ES model and ML model configurations) can be saved and used throughout an organization to provide a standardized data object decision process without further SME effort.

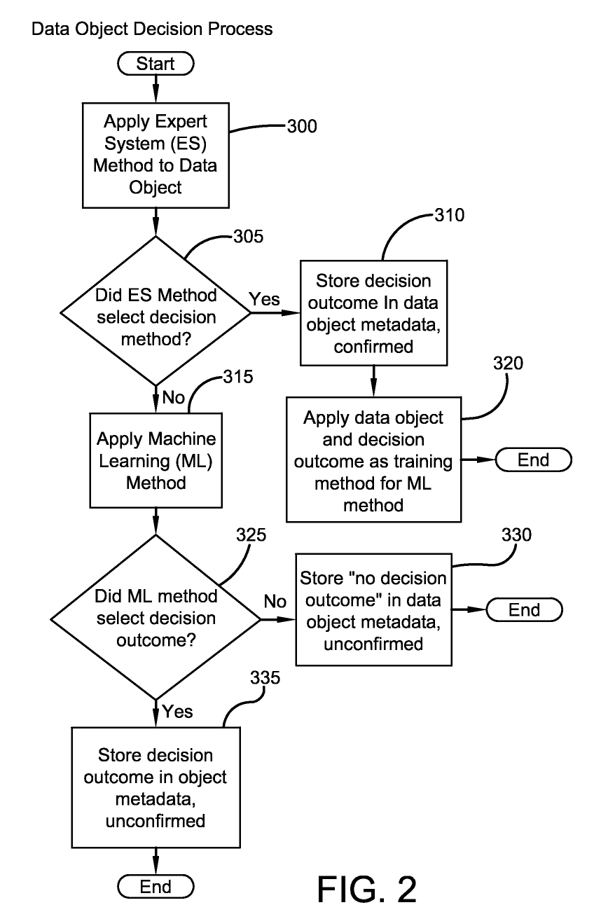

In the Data Object Decision Process shown in FIG. 2, the Expert Systems method is first applied to the new data object as shown in step 300. After the Expert Systems method has been applied, in step 305, the system checks whether a decision outcome has been determined. If the Expert Systems method has selected a decision outcome, then in step 310, that decision outcome is stored in the data object metadata as a confirmed outcome. Then, in step 320, that outcome is applied as a positive training example to the ML method. On the other hand, if the Expert Systems method did not select a decision outcome, then the Machine Learning method is applied in step 315. If the Machine Learning method selects a decision outcome, then that decision outcome is stored in the data object metadata as an unconfirmed outcome in step 335. If the Machine Learning method does not select a decision outcome, then the decision outcome is marked in the data object metadata as an unconfirmed value of “No Decision Outcome” in step 330.

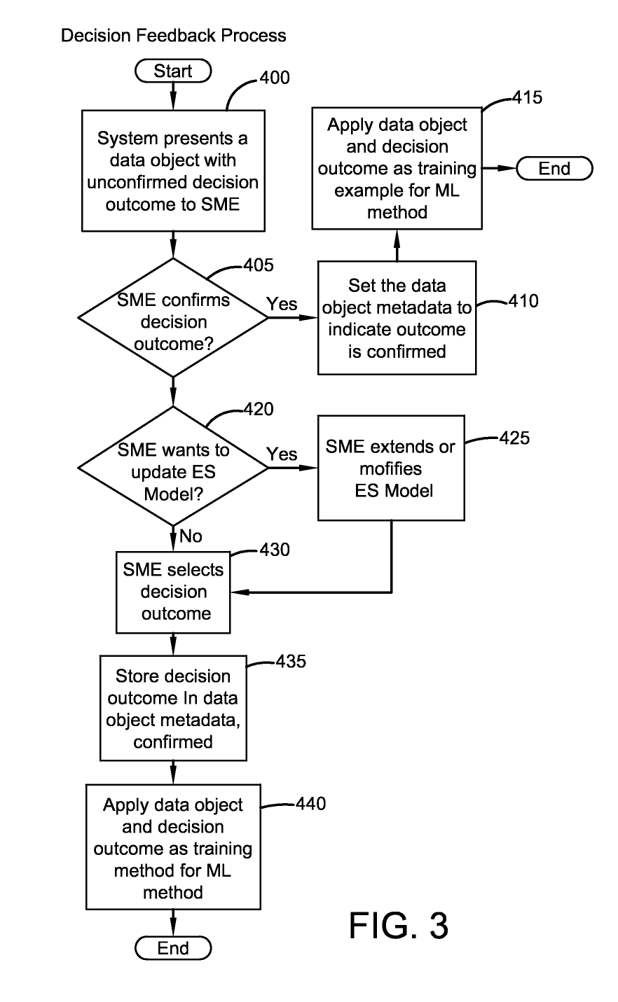

In the Decision Feedback Process shown in FIG. 3, the system presents the SME with a data object and an associated ML method decision outcome which is unconfirmed at step 400. The SME examines the data object and the decision outcome at step 405. If the SME determines that the decision outcome is correct, then this decision outcome is marked ‘confirmed’ in the data object metadata at step 410 and is provided to the Machine Learning method as a positive learning example at step 415. If the SME determines that the decision outcome is not correct, then the SME must decide whether this incorrect outcome warrants any changes to the ES method at step 420 and, if so, make these changes at step 425. In either case, the SME will then specify the correct decision outcome to the system at step 430. This correct decision outcome is then stored in the data object metadata as a confirmed outcome in step 435. This correct outcome is then applied as a corrected training example to the ML method at step 440. In some embodiments the ML method will modify its behavior differently when a training example shows that a previous decision outcome has been determined to be incorrect in step 440 as opposed to when a training example shows that a previous decision outcome has been determined to be correct in step 415. It should noted this application of the third artificial intelligence method is iterative and with no specific limit.

An Example of an ES-ML Document Categorization System

The following example is an ES-ML embodiment of the system that processes English text documents and selects a category-value from each level of a Category Tree (CT) of possible values. Within the document, each set of text characters delimited by spaces, tabs or punctuation is called a ‘term’.

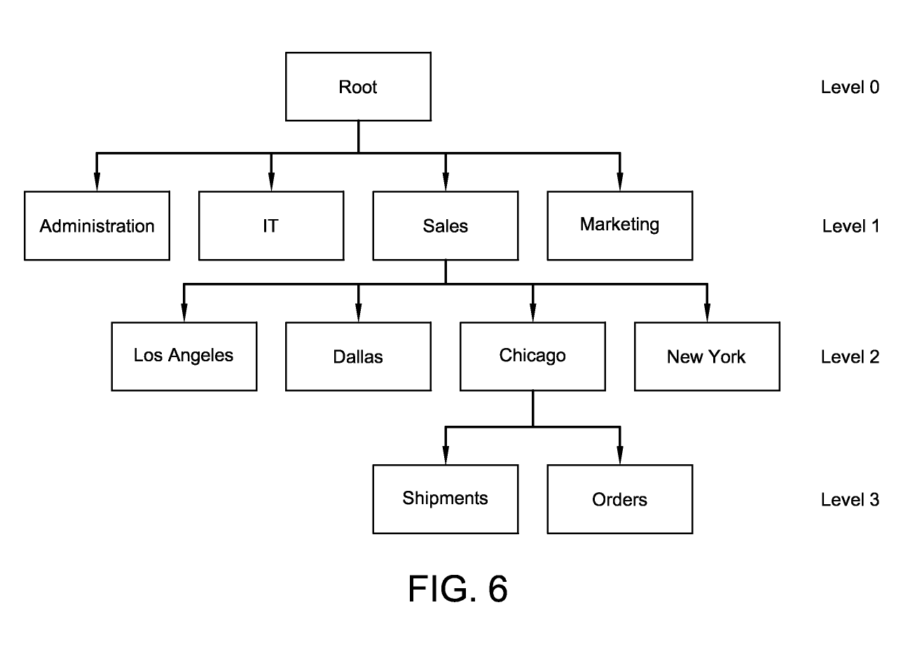

A Category Tree is a hierarchical data structure showing all possible category-values for a particular category-type at each level of the tree. Category-values are chosen from the top of the tree starting with the category-values directly below the root node, and continue down the tree. Selecting a particular category-value at one level of the tree constrains future category-value selections to the nodes that are ancestors below the selected node in the tree. An example of a CT is shown in FIG. 6.

This ES-ML embodiment follows the three phases described earlier. In the Training Phase, the SME can do any of the following:
(a) The SME can define Category Rules of the form “IF <condition> THEN <category-values>”, where the <condition> is a set of one or more conditions on the document contents, such as the presence or absence of certain terms in the document, and <category-values> is one or more category-values in the CT. The interpretation of this rule is that, if the <condition> is met by a new document, then the selected category-value(s) should be <category-values>.
(b) The SME can define Category Patterns, which are regular expressions that define one or more character patterns that may be in the document. If the pattern appears in the document, then the matched pattern from the document is the selected category-value. For example, if the category-type is Date, then the regular expression “[0-1][0-9]/[0-2][0-9]/20[0-9][0-9]” could be used to match a date such as “05/09/2013” in the document. This matched value becomes the selected category-value for this document.
(c) The SME can provide Training Documents, which are documents that have previously been assigned one or more category-values within the CT. The contents of these previously-categorized documents are analyzed and used to generate Category Term Vectors (CTVs) as described below. These CTVs are used by the embodiment to match new documents to a category-value that has been previously assigned to documents that are most similar to the new document.
(d) The SME can define a Drop List, which is a set of terms which will NOT be included when Category Term Vectors and/or Document Term Vectors are generated.
(e) The SME can specify Administrative Weights, which are numeric values assigned to terms that may appear within documents. If an Administrative_Weight value greater than 1 is assigned to a term, this indicates that the presence (or absence) of that term within a document should have more influence over how the document is categorized than it would otherwise. An Administrative_Weight value between 0 and 1 indicates that the term should have less influence over how a document is categorized than it would otherwise. An Administrative_Weight value of 0 indicates that the presence or absence of this term in a document should have no influence on how the document is categorized. An Administrative Weight value of 1 is the default value and indicates that the term frequency in the document, with no additional weighting, is used in determining how the document will be categorized.

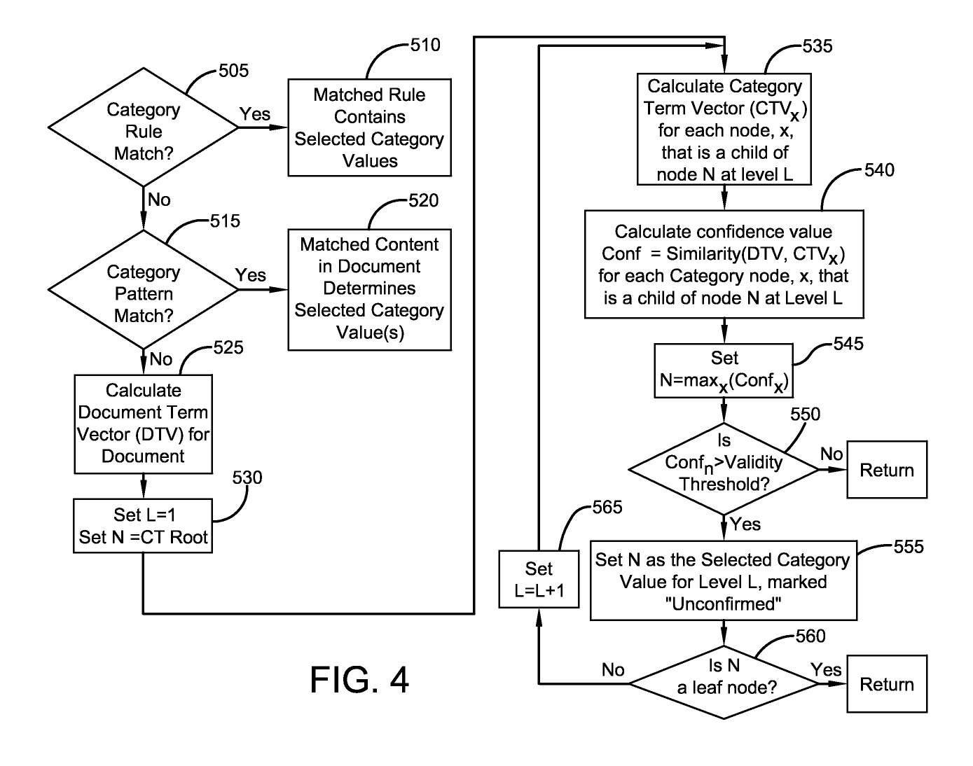

Once the Training Phase is complete, any new document will be processed as specified in the Example Category Value Selection Process for Documents shown in FIG. 4.

Overall, the Example Category Value Selection Process for Documents applies up to three categorization methods to select the best category value:
1. Rules-Based Categorization: The system will first check whether the conditions of any previously-defined Category Rule are met by this document. If so, then the matched Category Rule determines the Selected Category-Value(s). Rules-Based Categorization is an Expert Systems method.
2. Pattern-Based Categorization: If no Category Rule was matched, then the system will check whether any patterns defined by a Category Pattern are present in the document. If so, then the matched pattern value determines the Selected Category-Value(s). Pattern-Based Categorization is an Expert Systems method.
3. Nearest-Centroid-Based Categorization: If no Rule or Pattern is matched, then, starting with Level 1 of the CT, the system will select the best CT node at each level by calculating a Document Term Vector for the document, then calculating a Category Term Vector (CTV) for each node at the current CT level, and then selecting the node whose CTV is most similar to the DTV. Nearest-Centroid-Based Categorization is a supervised Machine Learning method.

In the Example Category Value Selection Process for Documents shown in FIG. 4, the system first checks for any category rule matches at step 505. If there are category rule matches, then these determine the confirmed Selected Category values at step 510 and the process ends. If there are no Category Rule matches, then the system checks for Category Pattern matches at step 515 and uses those to determine the confirmed Selected Category Values if matched at step 520.

If there are also no Category Pattern matches, then the process iterates through each level of the category tree, initializing level L=1 at step 525, choosing the best category-value at level L, and then incrementing L at step 565 before repeating the category selection process at the next level.

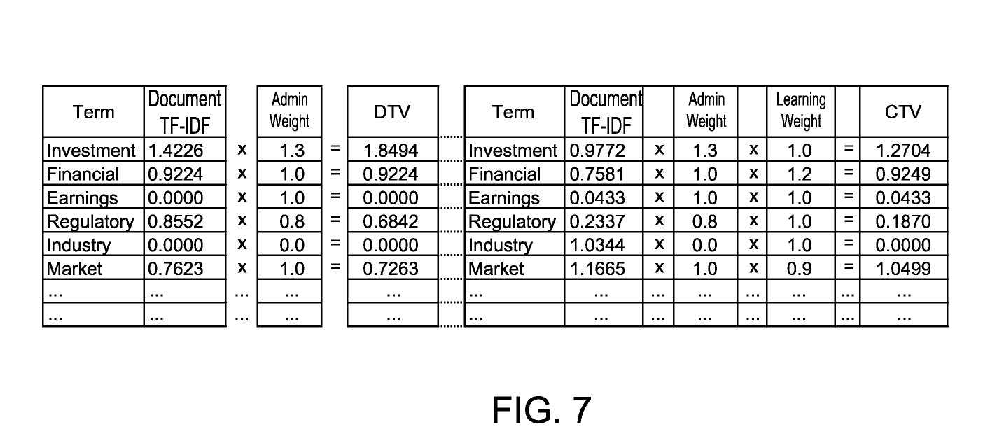

At each level, the process first calculates the Document Term Vector for the document at step 530. Details of the DTV calculation are shown in FIG. 7. Then, the process calculates a Category Term Vector (CTVₓ) for each possible category-value choice at level L at step 535 following the CTV calculation method shown in FIG. 7. Then, for each CTVₓ it calculates a corresponding Confidence value, Confₓ, at step 540 which is a measure of the similarity between vectors DTV and CTVₓ. This Similarity function returns a scalar numeric result such that, the greater the similarity between DTV and CTVₓ, the greater the value of Confₓ will be. Well-known vector similarity functions include Cosine Similarity, inverse Euclidean Distance, Mean Squared Error, and others.

By choosing the greatest value of Confₓ at step 545, the system selects the category-value whose CTVₓ is most similar to the DTV. The Confidence values are compared with a validity threshold at step 350. For Confidence values below a specified Validity Threshold value, the result is considered invalid. Otherwise the Selected Category Value is stored at step 555 for the current level L, but is marked “unconfirmed” to indicate that it may be changed during the Feedback Phase. The process then iterates to the next level and determines if the Selected Category Value is a Leaf node at step 560. If it is a leaf node, then the process increments the Level L by one at step 365 and proceeds to step 555.

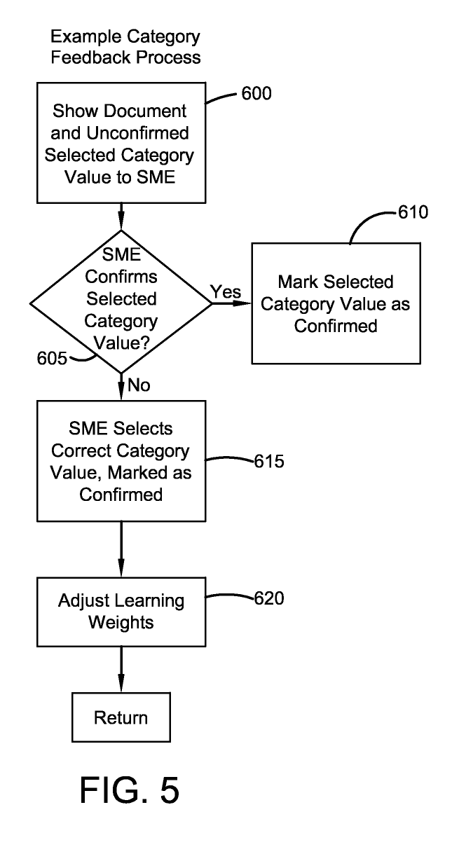

In the Feedback Phase, the system will follow the Example Category Feedback Process illustrated in FIG. 5. In this process, a document that was previously categorized but is unconfirmed is shown to the SME, along with the previously selected category-values at step 600. SME provides Feedback by indicating whether each selected category-value was correct or not at step 605. If the selected category-value was correct, then it is marked as Confirmed at step 610. Otherwise the SME will specify a new Correct Category Value at step 615. The Nearest-Centroid-based system will adjust its behavior by modifying Learning Weights to increase the categorization accuracy for similar documents in the future at step 620. Learning Weights are modified for the terms that have the greatest CTV values for the Correct Category Value. They are set so that these CTV term values are moved closer to the corresponding term values in the current DTV.

FIG. 7 shows how the DTV and CTVs are calculated. Each calculation begins by calculating a Term Frequency-Inverse Document Frequency (TF-IDF) value. The TF-IDF value is the product of two factors: the term frequency (TF) measures the relative frequency with which the term appears in the document or category; the inverse document frequency (IDF) measures the relative scarcity of documents containing this term within the category or level. These TF-IDF values are then multiplied by the corresponding Administrative Weights in both the DTV and CTVs. The results are then multiplied by the corresponding Learning Weights in the CTVs.

System accuracy will improve as the system continues to receive feedback from the SME. Once the SME determines that the system accuracy is sufficient, the Feedback Phase will end and the Production Phase will commence, allowing the system to continue to categorize new documents with little or no additional SME feedback. The resulting system configuration values, including all Categorization Rules, Categorization Patterns, and TF-IDF values of all terms across all categorized documents, will be saved. This system can now be used with this saved configuration anywhere across an enterprise, providing a standard automated process for choosing values for each category-type that has been optimized by the SME.

In certain embodiments, data objects will be created by scanning paper documents. In certain embodiments where paper documents are scanned, a staff may write on one or more pages of paper being scanned to provide additional instructions on how the system should select document categories.

In certain embodiments, data objects will be sent as e-mail attachments to a mailbox monitored by the system. In certain embodiments where data objects are sent as e-mail attachments, the staff sending the e-mail may type additional instructions into the e-mail subject or body about how the system should process the data object. In certain embodiments where data objects are sent as e-mail attachments, the system may use the source e-mail address identifying the sender of the e-mail as one factor in the decision.

In certain embodiments, data objects are processed when they are uploaded to a web server using a web page. In certain embodiments where data objects are processed when they are uploaded to a web server, the web page may include additional inputs allowing the uploading staff to specify additional instructions about how the system should process the data object. In certain embodiments where data objects are processed, when the data objects are uploaded to a web server the system may use the identity (login name) of the user completing the web page as a factor in making decisions about the data object.

In certain embodiments, a category tree structure will be based on the storage folder structure of the file system in which the data objects are stored. In certain embodiments, a category tree structure will be based on the hierarchical folder structure implemented within a Document Management System (DMS). In certain embodiments, a category tree structure will be based on the tree structure embodied in an enterprise directory service or a Domain Name Services (DNS) tree.

In certain embodiments the system may send reminders to an SME to provide Feedback on unconfirmed decisions that have been made by a Machine Learning method. If the SME does not provide Feedback by a time deadline, then a higher-level manager will be notified. The time intervals between reminders and the deadline for escalation to higher-level management may be determined by the system based on data object contents. In some of these embodiments, the notification system will include provisions for using contacts within an organizational chart, an enterprise directory service, or other managerial systems.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. A computer-implemented method for making decisions on data objects, comprising the steps of:
a) receiving data objects in a computer;
b) applying a first artificial intelligence method to a data object; and
c) applying a second artificial intelligence method to the results from the application of the first artificial intelligence method.

2. The computer-implemented method according to claim 1 wherein the first artificial intelligence method is applied to all data objects first, and then the second artificial intelligence method is applied to the results for all data objects.

3. The computer-implemented method according to claim 1 wherein the first artificial intelligence method is applied to each data object, and then the second artificial intelligence method is applied to the result for the same data object before another data object is processed.

4. The computer-implemented method according to claim 2, wherein the first artificial intelligence method includes an Expert Systems method or a Natural Language Processing method, wherein the second artificial intelligence method includes a Machine Learning method, wherein applying the second artificial intelligence method to the results from the application of the first artificial intelligence method includes selecting decision outcomes for each data object that the first artificial intelligence method did not select a decision outcome.

5. The computer-implemented method according to claim 2, wherein the first artificial intelligence method includes an Expert Systems method or a Natural Language Processing method, wherein the second artificial intelligence method is a supervised Machine Learning method, wherein the computer-implemented method further includes d) using decision outcomes from the first artificial intelligence method as training examples to train the second artificial intelligence method.

6. The computer-implemented method according to claim 2, wherein the first artificial intelligence method includes a Natural Language Processing method, wherein the Natural Language Processing method reduces the number of possible decision outcomes that are considered by the second artificial intelligence method.

7. The computer-implemented method according to claim 2, wherein the first artificial intelligence method includes a Natural Language Processing method, wherein applying the first artificial intelligence method to the data object includes reducing a set of data object properties that can be used by the second artificial intelligence method to make a decision.

8. The computer-implemented method according to claim 2, wherein the first artificial intelligence method includes a Natural Language Processing method, wherein applying the first artificial intelligence method to the data object includes setting the value of additional data object metadata values that are used by the second artificial intelligence method to make a decision.

9. The computer-implemented method according to claim 3, wherein the first artificial intelligence method includes an Expert Systems method or Natural Language Processing method, wherein the second artificial intelligence method includes a Machine Learning method, wherein applying the second artificial intelligence method to the results from the application of the first artificial intelligence method includes selecting decision outcomes for each data object for which the first artificial intelligence method did not select a decision outcome.

10. The computer-implemented method according to claim 3, wherein the first artificial intelligence method includes an Expert Systems method or Natural Language Processing method, wherein the second artificial intelligence method includes a supervised Machine Learning method, wherein the computer-implemented method further includes d) using the decision outcomes from the first artificial intelligence method as training examples to train the second artificial intelligence method.

11. The computer-implemented method according to claim 3, wherein the first artificial intelligence method includes a Natural Language Processing method, wherein applying the first artificial intelligence method to the data object includes reducing the number of possible decision outcomes that are considered by the second artificial intelligence method.

12. The computer-implemented method according to claim 3, wherein the first artificial intelligence method includes a Natural Language Processing method, wherein applying the first artificial intelligence method to the data object includes reducing the set of data object properties that can be used by the second artificial intelligence method to make the decision.

13. The computer-implemented method according to claim 3, wherein the first artificial intelligence method includes a Natural Language Processing method, wherein applying the first artificial intelligence method to the data object includes setting the value of additional data object metadata values that are used by the second artificial intelligence method to make the decision.

14. The computer-implemented method according to claim 1, wherein the data object comprises a text object.

15. A computer-implemented method for making decisions on data objects, comprising the steps of:
a) receiving data objects in a computer;
b) applying a first artificial intelligence method to the data object;
c) determining if the first artificial intelligence method selects a decision outcome for the data object;
d) if the first artificial intelligence method selects a decision outcome for the data object, then storing the decision outcome in the data object meta data; and
e) if the first artificial intelligence method does not select a decision outcome for the data object, then applying a second artificial intelligence method to the results from the application of the first artificial intelligence method.

16. The computer-implemented method according to claim 15 further including f) determining if the second artificial intelligence method selects a decision outcome for the data object after step e); and
g) storing a no decision outcome in the data object metadata if the second artificial intelligence method and the first artificial intelligence method do not select a decision outcome for the data object.

17. The computer-implemented method according to claim 16, further including h) storing the decision outcome in the data object metadata if the second artificial intelligence method selects a decision outcome for the data object.

18. The computer-implemented method according to claim 15 wherein the first artificial intelligence method includes an Expert Systems method or a Natural Language Processing method, wherein the second artificial intelligence method includes a Machine Learning method.

19. The computer-implemented method according to claim 15 further including f) presenting the data object to a third artificial intelligence method after applying a second artificial intelligence method to the results from the application of the first artificial intelligence method;
g) determining if the third artificial intelligence method confirms a decision outcome for the data object; and
h) if the third artificial intelligence method confirms a decision outcome for the data object, then setting the data object metadata to indicate that the outcome is confirmed.

20. The computer-implemented method according to claim 19 wherein the third artificial intelligence method is iterative and with no specific limit.

21. A non-transitory computer-readable medium for making decisions on data objects, comprising, instructions stored thereon, that when executed on a processor, perform the steps of:
a) receiving data objects in a computer;
b) applying a first artificial intelligence method to the data object; and
c) applying a second artificial intelligence method to the results from the application of the first artificial intelligence method.

22. The non-transitory computer-readable medium according to claim 21, wherein the first artificial intelligence method includes an Expert Systems method or a Natural Language Processing method, wherein the second artificial intelligence method includes a Machine Learning method, wherein applying the second artificial intelligence method to the results from the application of the first artificial intelligence method includes selecting decision outcomes for each data object that the first artificial intelligence method did not select a decision outcome.
